(19) United States
(12) Patent Application Publication
(10) Pub. No.: US 2025/0045829 A1
(43) Pub. Date: Feb. 6, 2025

(54) ASSET INVOKED REACTION INDICATION

(71) Applicant: Capital One Services, LLC, McLean, VA (US)

(72) Inventors: Claire M. ROWLETT, Washington, DC (US); Benjamin KINGSTON, Taylorsville, UT (US); Christopher WU, Ashburn, VA (US); Dhaval PATEL, Lansdale, VA (US); Mark MERLING, Arlington, VA (US); Mia RODRIGUEZ, Broomfield, CO (US); Michael MOSSOBA, Great Falls, VA (US)

(73) Assignee: Capital One Services, LLC, McLean, VA (US)

(21) Appl. No.: 18/228,058

(22) Filed: Jul. 31, 2023

(51) Int. Cl. G06Q 40/06

(52) U.S. Cl. CPC G06Q 40/06

(57) ABSTRACT

Disclosed herein are system, method, and computer program product embodiments for asset-invoked reaction indication. According to some aspects of this disclosure, a first device may request to send an asset to a second device. A response action for the asset may be identified based on a user profile associated with the second device and a type of the asset. The asset may be sent to the second device responsive to identifying the response action. The response action may be triggered based on an indication that the second device received the asset.

### BACKGROUND

People exchange gifts for various reasons. The joy of gift giving often comes from seeing the reaction of the recipient when they receive the gift. Gift-giving between distant individuals routinely occurs via mobile device transfers, electronic gift card exchanges, and remote product purchases via online shopping platforms. As such, a gift giver is often unable to observe the reaction of a gift recipient.

### BRIEF DESCRIPTION OF THE DRAWINGS

The accompanying drawings are incorporated herein and form a part of the specification.

FIG. 1 shows an example system for asset-invoked reaction indication, according to some aspects of this disclosure.

FIG. 2 shows a flowchart of an example method for asset-invoked reaction indication, according to some aspects of this disclosure.

FIG. 3 is an example computer system useful for implementing various embodiments.

In the drawings, like reference numbers generally indicate identical or similar elements. Additionally, generally, the left-most digit(s) of a reference number identifies the drawing in which the reference number first appears.

### DETAILED DESCRIPTION

Provided herein are system, apparatus, device, method and/or computer program product embodiments, and/or combinations and sub-combinations thereof, for asset-invoked reaction indication. According to some aspects of this disclosure, a first device may request to send an asset (e.g., gift, commodity, digital currency, non-fungible token, content item, item of value, message, loyalty point, digital coupon, voucher, etc.) to a second device. A response action for the asset may be identified based on a user profile associated with the second device and a type of the asset.

An asset management system, the first device, and/or the second device may store and/or access the user profile and/or other user profiles. The user profile may indicate, for example, that a user of the second device has various preferences on when, how, and/or why to receive assets. Preferences indicated by the user profile may specify different response actions for different types of assets. The asset may be sent to the second device responsive to identifying the response action.

The identified response action may be triggered based on an indication that the second device received the asset. For example, a triggered response action may include a notification and/or instruction for the user of the second device to activate a camera and microphone on the second device and capture a recording of the user as a gift is revealed on a display of the second device and/or via delivery of the gift to a location of the second device and/or user. The second device may send the recording to the first device. According to some aspects of this disclosure, the user of the second device may also send text messages, emojis, gifs, and/or the like to the first device along with the recording. A user of the first device may access the recording to identify a response to the gift by the user of the second device.

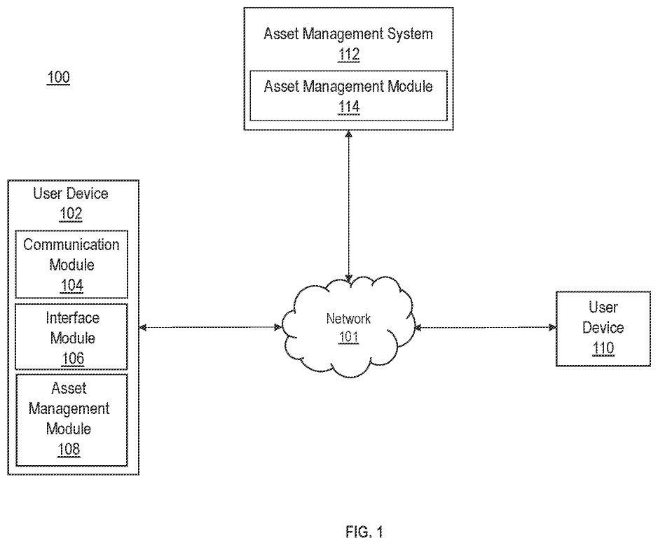

FIG. 1 shows an example system 100 for asset-invoked reaction indication. System 100 is merely an example of one suitable system environment and is not intended to suggest any limitation as to the scope of use or functionality of aspects described herein. Neither should the system 100 be interpreted as having any dependency or requirement related to any single module/component or combination of modules/components described therein.

According to some aspects of this disclosure, system 100 may include a network 101. According to some aspects of this disclosure, network 101 may include a packet-switched network (e.g., internet protocol-based network), a non-packet switched network (e.g., quadrature amplitude modulation-based network), and/or the like. According to some aspects of this disclosure, network 101 may include network adapters, switches, routers, modems, and the like connected through wireless links (e.g., radiofrequency, satellite) and/or physical links (e.g., fiber optic cable, coaxial cable, Ethernet cable, or a combination thereof). According to some aspects of this disclosure, network 101 may include public networks, private networks, wide area networks (e.g., Internet), local area networks, and/or the like. According to some aspects of this disclosure, network 101 may provide and/or support communication from a telephone, cellular phone, modem, and/or other electronic devices to and throughout the system 100. For example, system 100 may include and support communications between user devices 102 and 110 and an asset management system 112 via network 101.

User device 102 may include, but is not limited to, a smart device, a mobile device, a computing device, and/or any other device capable of communicating with network 101 and/or device/components in communication with network 101. According to some aspects of this disclosure, although user device 102 is shown and described in greater detail than user device 110, user devices 102 and 110 may be similarly configured and perform similarly and/or execute/operate with the same functionality.

User device 102 may include a communication module 104 that facilitates and/or enables communication with network 101 (e.g., devices, components, and/or systems of the network 101, etc.), asset management system 112 (e.g., devices, components, and/or systems of asset management system 112, etc.), user device 110, and/or any other device/component of the system 100. According to some aspects of this disclosure, communication module 104 may include any hardware and/or software necessary to facilitate communication including, but not limited to a modem, transceiver (e.g., wireless transceiver, etc.), digital-to-analog converter, analog-to-digital converter, encoder, decoder, modulator, demodulator, tuner (e.g., QAM tuner, QPSK tuner), and/or the like. For example, communication module 104 may include multiple radio interfaces that support various wireless communication protocols and/or standards (e.g., Wi-Fi, BLUETOOTH™, LTE, LTE-A, ZigBee, Ant+, near field communications (NFC), UWB (Ultra-wideband), 3G, 4G, 5G, PCS, GSM, etc.). Accordingly, the UE may need to simultaneously operate multiple radio interfaces corresponding to multiple wireless communication protocols and/or standards.

User device 102 may include an interface module 106. Interface module 106 enables a user to interact with user device 102, network 101, user device 110, asset management system 112, and/or any other device/component of the system 100. Interface module 106 may include any interface for presenting and/or receiving information to/from a user.

Interface module 106 may include, but is not limited to, a web browser, a user interface of an application (e.g., Capital One Mobile App, etc.), and/or the like. Other software, hardware, and/or interfaces can be used to provide communication between user device 102, network 101, user device 110, asset management system 112, and/or any other device/component of the system 100.

According to some aspects of this disclosure, interface module 106 may be used to display, request, and/or send data/information (e.g., assets, etc.), for example, via asset management module 108, from a local source and/or a remote source, such as network 101, user device 110, asset management system 112, and/or any other device/component of the system 100. According to some aspects of this disclosure, interface module 106 may be and/or may include any interface for presenting and/or receiving information to/from a user.

Interface module 106 may include one or more input devices and/or components, for example, such as a keyboard, a pointing device (e.g., a computer mouse, remote control), a microphone, a joystick, a tactile input device (e.g., touch screen, gloves, etc.), and/or the like. According to some aspects of this disclosure, input devices and/or components of interface 106 may include hardware input devices and/or components, software input devices and/or components, virtual input devices and/or components, physical input devices and/or components, and/or the like. According to some aspects of this disclosure, interaction with the input devices and/or components may enable a user to view, access, request, and/or navigate a user interface generated, accessible, and/or displayed by interface module 106. According to some aspects of this disclosure, interaction with the input devices and/or components may enable a user to manipulate and/or interact with components of a user interface.

According to some aspects of this disclosure, asset management module 108, enables user device 102 to send assets, receive assets, customize and send responses to assets according to various response actions, and/or receive customized responses to assets according to various response actions. For example, asset management module 108 enables the manipulation and/or transfer of assets (e.g., gifts, commodities, digital currency, non-fungible tokens, content items, items of value, messages, loyalty points, digital coupons, vouchers, etc.).

Asset management module 108, may communicate with asset management system 112 (e.g., asset management module 114, etc.) via various communication protocols, including but not limited to HTTPS, SSL, and/or TLS. According to some aspects of this disclosure, communication between asset management module 108 and asset management system 112 (e.g., asset management module 114, etc.) may be secured using one or more encryption techniques to ensure the privacy and security of communicated data/information.

According to some aspects of this disclosure, asset management module 108 may operate with interface module 108 to enable a user of user device 102 to browse through an e-commerce platform supported and/or provided via asset management system 112 and select assets/items for purchase and/or transferal to user device 110.

Asset management module 108, in communication with asset management system 112 (e.g., asset management module 114, etc.), may facilitate asset delivery to user device 110. For example, according to some aspects of this disclosure, asset management module 108 enables a user to select an asset and choose an option to gift it to another user, such as a user of user device 110. according to some aspects of this disclosure, asset management module 108 enables a user to enter asset recipient (e.g., user device 110, etc.) details, including, but not limited to a device identifier, a phone number, a user identifier, and/or the like. Asset management module 108 may communicate with asset management system 112 (e.g., asset management module 114, etc.) to process the asset delivery and may deduct any necessary funds, digital assets, and/or the like from a user account, payment account, digital wallet, and/or the like associated with the user device 102.

Asset management module 108 enables tracking of the status of asset deliveries. For example, asset management module 108 enables a user to view an asset purchase/order history, track asset shipment, and receive notifications about the delivery status.

Asset management system 112 may include a payment network, a blockchain network, an asset transferal network, and/or may support/facilitate transactions (e.g., gift exchange transactions, financial transactions, asset exchange transactions, cryptocurrency-related transactions, digital asset-related transactions, etc.). According to some aspects of this disclosure, asset management system 112 may facilitate and/or support e-commerce and asset delivery services.

According to some aspects of this disclosure, asset management system 112 may include a payment network that may provide, facilitate, and/or support one or more applications, and/or protocols, such as Capital One Mobile App, and the like. According to some aspects of this disclosure, user devices 102 and 110 may be configured to communicate with the payment network of asset management system 112 and transmit pull and push payment requests/messages. For example, the pull and push payment requests/messages may be payment requests/messages associated with monetary gift transactions, inter-device payment requests and/or funds transferals, and/or the like. According to some aspects of this disclosure, user devices 102 and 110 may be configured (via an asset management module 108, an asset management module 1116, etc.) with an application and/or an application programming interface (API) that includes services, libraries, code, a combination thereof, and/or the like. The application and/or the API may enable user devices 102 and 110 to communicate with an application and/or an application programming interface (API) of asset management system 112, such as asset management module 114.

Asset management module 114 may communicate with the payment network of asset management system 112 and send pull and push payment messages. For example, if a user of user device 102 wants to send a monetary gift to user device 110 (e.g., a user of user device 110, etc.), user device 102 may send a message, via asset management module 108, etc., to the payment network of asset management system 112 to pull monetary value (e.g., an allocated gift amount, etc.) from an issuer entity (e.g., a device/network associated with a financial institution that issues a payment account, etc.) based on a request from a digital wallet and/or the like of user device 102. The pulled monetary value may be pushed to a receiving entity (e.g., a device/network associated with a financial institution that issues a payment account, etc.) associated with user device 110, or vice versa, etc.

According to some aspects of this disclosure, asset management system 112 may include a blockchain. According to some aspects of this disclosure, asset management module 114 may communicate with the blockchain to facilitate the exchange of assets between user device 102 and user device 110. The blockchain may be a distributed database that maintains records in a readable manner and that is resistant to tampering. The blockchain may include a system of interconnected blocks containing data. The blocks can hold transfer data, smart contract data, and/or other information (e.g., digital assets, etc.) as desired. Each block may link to the previous block and may include a timestamp. When implemented in support of asset management system 112, the blockchain may serve as an immutable log for API transactions and related communications. According to some aspects of this disclosure, the blockchain may be a peer-to-peer network that is private, consortium, and/or public (e.g., Ethereum, Bitcoin, etc.). Consortium and private networks may offer improved control over the content of the blockchain and public networks (e.g., network 101, etc.) may leverage the cumulative computing power of the network to improve security. According to some aspects of this disclosure, the blockchain may be implemented using technologies, for example, Ethereum GETH, eth-light wallet, or other suitable blockchain interface technologies. The blockchain may be maintained on various nodes in the form of copies of the blockchain. Validation of API transactions may be added to the blockchain by establishing consensus between the nodes based on proof of work, proof of stake, practical byzantine fault tolerance, delegated proof of stake, or other suitable consensus algorithms.

Asset management module 114 may include and/or be in communication with storage. According to some aspects of this disclosure, asset management module 114 may store user profiles for users of user devices. According to some aspects of this disclosure, a user profile may include data regarding interactions, actions, and/or the like for a user device or a user of the user device. According to some aspects of this disclosure, user data stored within a user profile may include but is not limited to, browsing history, search history, purchase history, social media activity, location data, and device usage data.

Asset management module 114 may include and/or be in communication with one or more predictive models. According to some aspects of this disclosure, asset management module 114 may use a predictive model trained to analyze a user profile and forecast and/or predict sentiment of a user at any given time an asset is to be sent to a user device of the user and/or the user. A forecasted and/or predicted sentiment may indicate how the user of the user device will respond to the asset. For example, if user data (e.g., historical data, transactional data, social media information, etc.) indicates a user recently experienced a tragedy, is tired, or got laid off from their job, then the user may not want to receive a gift at a given time. Or the user may be receptive to only certain types of gifts (e.g., money vs. get well soon messages). According to some aspects of this disclosure, asset management module 114 may forecast and/or predict any user scenario as it relates to sentiment for receiving an asset.

For example, system 100 may support an e-commerce platform where a user of user device 102 wants to send a gift to a user of user device 110 for an upcoming birthday. Asset management module 114 may use a predictive model to analyze user information related to the user of user device 110 including, but not limited to, product browsing and purchase history, social media activity, credit history and reputational information, and/or the like to forecast and/or identify interest and sentiments of the user of user device 110. For example, if the interest and sentiment analysis suggest the user of user device 110 is interested in fashion and accessories, asset management module 114 may suggest and/or recommend potential gift options from those categories to the user of user device 110. However, if the interest and sentiment analysis indicates the user of user device 110 has an interest in technology and gadgets, asset management module 114 may suggest and/or recommend alternative gift options aligned with the current preferences of the user of user device 110.

As another example, system 100 may facilitate customer support gift suggestions and recommendations for a customer support and management platform. For example, user device 102 may be associated with customer and service support systems where users of user device 102 aim to provide personalized gifts to customers who have had a positive experience with their service. A customer of the service may be a user of user device 110. Before user device 102 sends a gift to the user of user device 110, asset management module 114 may use a predictive model to analyze customer feedback, facilitate sentiment analysis of user support reports and events, and/or collect customer satisfaction and rating information. If, based on the sentiment analysis, the predictive model forecasts that the user of user device 110 is happy and/or satisfied with a service (or product), the predictive model suggests and/or recommends gifts to be sent to the user of user device 110 that correspond to the service (or product). For example, gifts may be tiered and offered according to the level of customer experience. Therefore, if the sentiment analysis indicates the user of user device 110 is mildly satisfied but not overly enthusiastic with a service (or product), the predictive model may suggest and/or recommend sending the user of user device 110 a more modest (e.g., lower tiered, etc.) yet thoughtful gift to acknowledge the positive experience. If the sentiment analysis indicates the user of user device 110 is unsatisfied with a service (or product), the predictive model may suggest and/or recommend sending the user of user device 110 certain types of gift, such as a monetary gift, reward, coupon, and/or the like.

As another example, in a corporate and/or business entity setting, system 100 may facilitate an employee and/or team member recognition program to reward performance. When a user of user device 110, such as a manager of a business or entity, wants to acknowledge the achievements of an employee and/or team member, a predictive model of asset management module 114 may analyze various business/entity data sources, project performance metrics, peer feedback, employee engagement surveys, and/or the like to forecast a sentiment towards the employee and/or team member (e.g., a user of user device 110, etc.). If the sentiment analysis forecasts, identifies, and/or predicts that the employee and/or team member is highly motivated and satisfied, the predictive model may suggest and/or recommend sending the employee and/or team member a physical gift, monetary gift, and/or bonus. However, if the sentiment analysis indicates that the employee and/or team member may be going through a challenging period or feeling overwhelmed, the predictive model may suggest and/or recommend sending the employee and/or team member a gift of support (e.g., training material, meditation-related material, spiritual information, etc.) or additional resources instead of a physical gift, monetary gift, and/or bonus.

According to aspects of this disclosure, predictive models of asset management module 114 may be utilized in different contexts to identify sentiment and tailor gift-giving decisions accordingly. The specific data sources and features used for sentiment analysis may vary based on the scenario and available information.

Asset management module 114 may also use real-time data (e.g., social media activity, location data, and device usage data) to update a user profile and refine the forecasting and/or prediction of user sentiment. For example, if the user is currently at a funeral or posting about a recent job loss, asset management module 114 may predict that the user is not receptive to receiving an asset (or a type of asset) at the moment.

According to some aspects of this disclosure, asset management module 114 may provide recommendations for assets based on a forecasted and/or predicted sentiment of a user. For example, if a user of user device 110 is forecasted and/or predicted to be in a positive mood, asset management module 114 may send a notification to user device 102 to recommend an asset that is upbeat and cheerful. According to some aspects of this disclosure, if a user of user device 110 is forecasted and/or predicted to be in a negative mood, asset management module 114 may send a notification to user device 102 to recommend an asset that is comforting and supportive.

Predictive models of asset management module 114 may be trained on a large dataset of user information. User information may include, but is not limited to, demographic information, user behavior, user-generated content (e.g., social media comments, product/service reviews, etc.), transactional information (e.g., product/service purchase data, bank account data, healthcare expenses, digital wallet-related information, blockchain-related information, etc.).

According to some aspects of this disclosure, training a predictive model(s) may include data preprocessing, embedding, and model selection. For example, during data preprocessing, user data is cleaned and preprocessed to remove noise and irrelevant information. Data preprocessing may include text normalization, stop word removal, tokenization, and/or the like.

During the embedding phase of training a predictive model, preprocessed user data may be converted into vector representations using word embedding techniques, such as Word2Vec and GloVe. Embedding enables the predictive model to capture the semantic meaning of user data. Predictive models of asset management module 114 may use embeddings in sequence modeling tasks, such as sentiment analysis or machine translation, where the order of words or context of user information matters. For example, embedding vectors can be combined with recurrent or convolutional neural network architectures to capture the sequential dependencies and semantic meaning within user information.

An embedding space using predictive models of asset management module 114 may be trained on a large corpus of text-based user data, to identify that words like “sad” and “upset” are similar in meaning and have similar vector representations. This semantic information may be utilized by a predictive model of asset management module 114 to understand the context and meaning of user data and/or inputs. Embeddings enable predictive models of asset management module 114 to generalize by capturing semantic similarities across different data points. If a predictive model of asset management module 114 encounters unseen words or user features when forecasting a sentiment and/or the like, it can still make reasonable inferences based on the learned embeddings. Furthermore, predictive models of asset management module 114 may use pre-trained embeddings, such as word2vec or GloVe, as a starting point, leveraging knowledge from large-scale training data (e.g., user information, etc.) and allowing the predictive models to benefit from transfer learning.

According to some aspects of this disclosure, during model selection, a predictive model architecture is chosen based on the performance of a validation dataset. According to some aspects of this disclosure, the chosen predictive model architecture may include a deep neural network with multiple hidden layers.

According to some aspects of this disclosure, predictive models of asset management module 114 may be trained on preprocessed user data using backpropagation and stochastic gradient descent. According to some aspects of this disclosure, the training objective is to minimize the mean squared error between the predicted sentiment and the true sentiment. According to some aspects of this disclosure, the predictive model may be evaluated on a test dataset to assess its performance. According to some aspects of this disclosure, evaluation metrics may include accuracy, precision, recall, and F1 score.

According to some aspects of this disclosure, the trained predictive model included and/or in communication with asset management module 114 may be applied to forecast sentiments for users of user devices. According to some aspects of this disclosure, when historical data for a user is input into the predictive model, the predictive model generates a sentiment forecast for the user. For example, the input data may include a user's demographic information, user behavior, and user-generated content. The output of the predictive model may be a sentiment score, which represents the user's sentiment toward an asset, product, service, and/or the like.

According to some aspects of this disclosure, a trained predictive model included and/or in communication with asset management module 114 may be used to analyze social media data, such as tweets and comments, to understand the sentiment of users towards a particular asset, product, service, and/or the like. According to some aspects of this disclosure, the trained predictive model may be used to analyze user feedback, such as product reviews and surveys, to understand the sentiment of users towards an asset, product, service, and/or the like. According to some aspects of this disclosure, a trained predictive model may be used to analyze various forms of transactional information (e.g., product/service purchase data, bank account data, healthcare expenses, digital wallet-related information, blockchain-related information, etc.)

According to some aspects of this disclosure, based on a forecasted and/or predicted sentiment of a user of user device 110 towards receiving an asset from user device 102, asset management module 114 may identify a response action for the user device 110. According to some aspects of this disclosure, to identify a response action for asset transferal (e.g., for an asset sent to user device 110 from user device 102, etc.), asset management module 114 may access a user profile to identify user configurable response parameters for various types of the assets. Asset management module 114 may map (e.g., via a look-up table, etc.) a response parameter to a response action for an asset.

According to some aspects of this disclosure, a user profile and/or asset management module 114 may store a plurality of response actions. Asset management module 114 may trigger any type of response action. According to some aspects of this disclosure, asset management module 114 may send an instruction, notification, signal, and/or the like indicative of a response action to a user device.

For example, according to some aspects of this disclosure, a response action may include asset management module 114 sending an instruction to a user device (e.g., user device 110, etc.) that causes at least one of audio content indicative of a user of user device (e.g., user device 110, etc.) or video content indicative of the user to be sent to another user device (e.g., user device 102, etc.) to indicate a user's response to receiving an asset sent to the user device by the other device. For example, asset management module 114 may send a notification and/or instruction for the user of user device 110 to activate a camera and/or microphone of user device 110 (or the notification and/or instruction may automatically initiate the camera and/or microphone) and capture a recording of the user as a gifted asset is revealed on a display of user device 110 and/or via delivery of the gifted asset to a location of user device 110. According to some aspects of this disclosure, user device 110 may display an interactive notification once the recording of the user is captured. Interaction with the interactive notification may enable the user to review, approve, deny, and/or redo the recording. For example, the user of user device 110 may decide whether to send the recording based on a selection of a portion of the interactive notification.

According to some aspects of this disclosure, a response action may include asset management module 114 sending an instruction to a user device (e.g., user device 110, etc.) that causes an emotive avatar of a user of the user device to be sent to another user device (e.g., user device 102, etc.) to indicate and/or obfuscate a user's response to receiving an asset sent to the user device by the other device. For example, an avatar may be selected for a user of a user device when a forecasted sentiment for the user indicates the user may be sad, but wants to send an upbeat and/or gratified avatar to another user device for sending the asset.

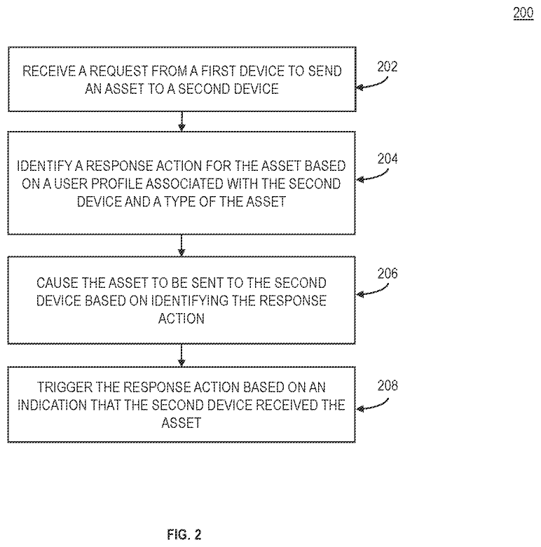

FIG. 2 is a flowchart for a method 200 for asset-invoked reaction indication, according to some aspects of this disclosure. Method 200 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 2, as will be understood by a person of ordinary skill in the art.

Method 200 shall be described with reference to FIG. 1. However, method 200 is not limited to that example embodiment.

In 202, computing management system 112 receives a request from a first device (e.g., user device 102, etc.) to send an asset to a second device.

For example, the first device may include an application and/or the like with a user interface that enables requests to send assets to be sent to computing management system 112. The application and/or the like may include, and/or the user interface may display, options for selecting various assets, and delivery methods (e.g., electronic transferals, physical shipping, exchange of resource/asset access links, etc.) for the assets. Based on user interaction with the application and/or user interface, computing management system 112 may receive the request from the first device to send the asset to the second device.

According to some aspects of this disclosure, computing management system 112 may receive a request from a first device (e.g., user device 102, etc.) to send an asset to the second device, and computing management system 112 may select and/or recommend a type of asset to the second device. For example, the request to send the asset may include preferences for a type of response to be invoked by the reception of an asset, timing information for when an asset is to be sent, environment/scenario and/or context information (e.g., e-commerce, customer service platforms, corporate and/or business entity settings, etc.) that dictate types of assets to be sent. For example, in a customer service and/or commercial scenario, computing management system 112 may identify assets that include coupons, reward tokens/vouchers, and/or consumer products that may be sent to the second device. In a corporate and/or business entity setting, computing management system 112 may identify assets that include achievement plaques, monetary assets and/or bonuses, finiacial gift cards, and/or the like. Computing management system 112 may identify any type of asset to be sent to the second device based on information received with the request from the first device to send an asset to a second device.

In 204, computing management system 112 identifies a response action for the asset. For example, computing management system 112 may identify the response action for the asset based on a user profile associated with the second device and a type of the asset.

According to some aspects of this disclosure, computing management system 112 may identify the response action for the asset by accessing the user profile. For example, computing management system 112 may determine the user profile based on an identifier of the second device received with the request to send the asset and a plurality of response parameters indicated by the user profile. According to some aspects of this disclosure, computing management system 112 may map a response parameter of the plurality of response parameters for the type of the asset to the response action for the asset. For example, computing management system 112 may use a look-up table and/or the like to map the response parameter for the type of the asset to the response action for the asset.

According to some aspects of this disclosure, computing management system 112 may identify the response action for the asset by accessing the user profile and historical information for a user of the second device indicated by the user profile. For example, computing management system 112 may determine the user profile based on an identifier of the second device received with the request to send the asset. The user profile may indicate the historical information for the user. According to some aspects of this disclosure, the historical information may include, but is not limited to, indications of previous assets received by the user of the second device, indications of social media interactions associated with the user of the second device, scheduling information, indications of previous transactions, online tracking data, information extracted from the second user device, and/or the like. According to some aspects of this disclosure, computing management system 112 may receive a forecasted sentiment for the user of the second device. For example, computing management system 112 may receive the forecasted sentiment from a predictive model based on the historical data for the user input to the predictive model. According to some aspects of this disclosure, the predictive model may be pre-trained to forecast sentiments for users based on user information. According to some aspects of this disclosure, computing management system 112 may map the forecasted sentiment to the response action for the asset.

In 206, computing management system 112 causes the asset to be sent to the second device. For example, computing management system 112 may cause the asset to be sent to the second device based on identifying the response action. According to some aspects of this disclosure, computing management system 112 causing the asset to be sent to the second device may include sending the second device an interactive notification (e.g., an email, a URL, a text message, etc.) that causes the second device to display of the asset based on an interaction with the interactive notification.

According to some aspects of this disclosure, computing management system 112 causing the asset to be sent to the second device may include causing the asset to be sent to the second device from at least one of the first device or a content source.

In 208, computing management system 112 triggers the response action. For example, computing management system 112 may trigger the response action based on an indication that the second device received the asset. According to some aspects of this disclosure, the response action may include sending an instruction to the second device that causes audio content indicative of a user of the second device, video content indicative of the user, and/or the like to be sent to the first device.

According to some aspects of this disclosure, the response action may include sending an instruction to the second device that causes an emotive avatar of a user of the second device to be sent to the first device. Alternatively, a video may be sent from the second device to the first device that shows the reaction of the recipient of the asset. According to some aspects of this disclosure, the second device may review and/or approve the video prior to the video being sent from the second device to the first device. For example, the second device may display an interactive notification responsive to video and/or any other content being captured by the second device. Interaction with the interactive notification may enable a user of the second device to control whether the video and/or any other content captured by the second device is sent to the first device.

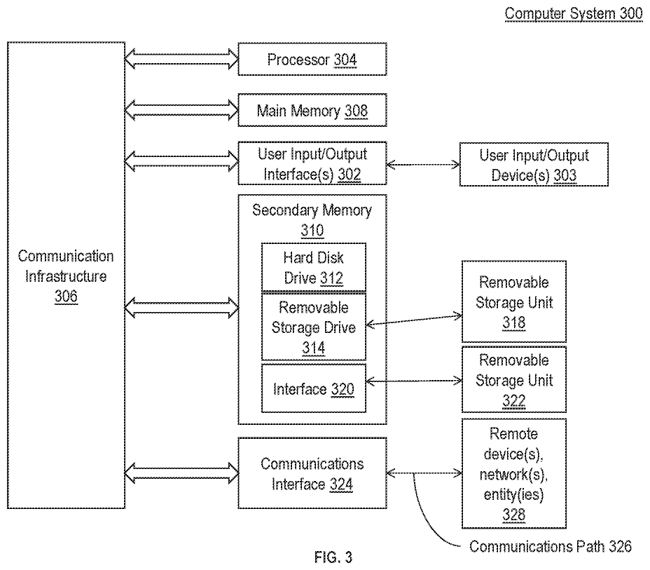

FIG. 3 is an example computer system useful for implementing various embodiments. Various embodiments may be implemented, for example, using one or more well-known computer systems, such as computer system 300 shown in FIG. 3. One or more computer systems 300 may be used, for example, to implement any of the embodiments discussed herein, as well as combinations and sub-combinations thereof. According to some aspects of this disclosure, any device/component described herein may be implemented using the computer system 300. According to some aspects, the computer system 300 may be used to implement method 300 and/or any other methods and/or steps described herein.

Computer system 300 may include one or more processors (also called central processing units, or CPUs), such as a processor 304. Processor 304 may be connected to a communication infrastructure or bus 306.

Computer system 300 may also include user input/output device(s) 303, such as monitors, keyboards, pointing devices, etc., which may communicate with communication infrastructure or bus 306 through user input/output device(s) 302.

One or more of processors 304 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 300 may also include a main or primary memory 308, such as random access memory (RAM). Main memory 308 may include one or more levels of cache. Main memory 308 may have stored therein control logic (i.e., computer software) and/or data.

Computer system 300 may also include one or more secondary storage devices or memory 310. Secondary memory 310 may include, for example, a hard disk drive 312 and/or a removable storage device or drive 314. Removable storage drive 314 may be a floppy disk drive, a magnetic tape drive, a compact disk drive, an optical storage device, a tape backup device, and/or any other storage device/drive.

Removable storage drive 314 may interact with a removable storage unit 318. The removable storage unit 318 may include a computer-usable or readable storage device having stored thereon computer software (control logic) and/or data. Removable storage unit 318 may be a floppy disk, magnetic tape, compact disk, DVD, optical storage disk, and/any other computer data storage device. Removable storage drive 314 may read from and/or write to the removable storage unit 318.

Secondary memory 310 may include other means, devices, components, instrumentalities, and/or other approaches for allowing computer programs and/or other instructions and/or data to be accessed by computer system 300. Such means, devices, components, instrumentalities, and/or other approaches may include, for example, a removable storage unit 322 and an interface 320. Examples of the removable storage unit 322 and the interface 320 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 300 may further include a communication or network interface 324. Communication interface 324 may enable computer system 300 to communicate and interact with any combination of external devices, external networks, external entities, etc. (individually and collectively referenced by reference number 328). For example, communication interface 324 may allow computer system 300 to communicate with external or remote devices 328 over communications path 326, which may be wired and/or wireless (or a combination thereof), and which may include any combination of LANs, WANs, the Internet, etc. Control logic and/or data may be transmitted to and from computer system 300 via communication path 326.

Computer system 300 may also be any of a personal digital assistant (PDA), desktop workstation, laptop or notebook computer, netbook, tablet, smartphone, smartwatch or other wearables, appliance, part of the Internet-of-Things, and/or embedded system, to name a few non-limiting examples, or any combination thereof.

Computer system 300 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 300 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats, and/or schemas may be used, either exclusively or in combination with known or open standards.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 300, main memory 308, secondary memory 310, and removable storage units 318 and 322, as well as tangible articles of manufacture embodying any combination of the foregoing. Such control logic, when executed by one or more data processing devices (such as computer system 300), may cause such data processing devices to operate as described herein.

Based on the teachings contained in this disclosure, it will be apparent to persons skilled in the relevant art(s) how to make and use embodiments of this disclosure using data processing devices, computer systems, and/or computer architectures other than that shown in FIG. 3. In particular, embodiments can operate with software, hardware, and/or operating system implementations other than those described herein.

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

Additionally and/or alternatively, while this disclosure describes exemplary embodiments for exemplary fields and applications, it should be understood that the disclosure is not limited thereto. Other embodiments and modifications thereto are possible and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

One or more parts of the above implementations may include software. Software is a general term whose meaning of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “an aspect,” “aspects,” “one embodiment,” “an embodiment,” “an example embodiment,” or similar phrases, indicate that the embodiment described can include a particular feature, structure, or characteristic, but every embodiment can not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments, but should be defined only in accordance with the following claims and their equivalents.

What is claimed is:

1. A computer-implemented method for asset-invoked reaction indication, comprising:
receiving, from a first device, a request to send an asset to a second device;
identifying, based on a user profile associated with the second device and a type of the asset, a response action for the asset;
causing, based on the identifying the response action, the asset to be sent to the second device; and
triggering, based on an indication that the second device received the asset, the response action.

2. The method of claim 1, wherein the identifying the response action for the asset comprises:
determining, based on an identifier of the second device received with the request to send the asset, the user profile and a plurality of response parameters indicated by the user profile; and
mapping a response parameter of the plurality of response parameters for the type of the asset to the response action for the asset.

3. The method of claim 1, wherein the response action comprises sending an instruction to the second device that causes at least one of audio content indicative of a user of the second device or video content indicative of the user to be sent to the first device.

4. The method of claim 1, wherein the identifying the response action for the asset comprises:
determining, based on an identifier of the second device received with the request to send the asset, the user profile and historical information for a user of the second device indicated by the user profile;
receiving from a predictive model trained to forecast sentiments for users based on user information, based on the historical data for the user input to the predictive model, a forecasted sentiment for the user of the second device, and
mapping the forecasted sentiment to the response action for the asset.

5. The method of claim 4, wherein the response action comprises sending an instruction to the second device that causes an emotive avatar of a user of the second device to be sent to the first device.

6. The method of claim 1, wherein the causing the asset to be sent to the second device comprises sending the second device an interactive notification that causes the second device to display the asset based on an interaction with the interactive notification.

7. The method of claim 1, wherein the causing the asset to be sent to the second device comprises causing the asset to be sent to the second device from at least one of the first device or a content source.

8. A system, comprising:
a memory; and
at least one processor coupled to the memory and configured to perform operations for asset-invoked reaction indication, the operations comprising:
receiving, from a first device, a request to send an asset to a second device;
identifying, based on a user profile associated with the second device and a type of the asset, a response action for the asset;
causing, based on the identifying the response action, the asset to be sent to the second device; and
triggering, based on an indication that the second device received the asset, the response action.

9. The system of claim 8, wherein the identifying the response action for the asset comprises:
determining, based on an identifier of the second device received with the request to send the asset, the user profile and a plurality of response parameters indicated by the user profile; and
mapping a response parameter of the plurality of response parameters for the type of the asset to the response action for the asset.

10. The system of claim 8, wherein the response action comprises sending an instruction to the second device that causes at least one of audio content indicative of a user of the second device or video content indicative of the user to be sent to the first device.

11. The system of claim 8, wherein the identifying the response action for the asset comprises:
determining, based on an identifier of the second device received with the request to send the asset, the user profile and historical information for a user of the second device indicated by the user profile;
receiving from a predictive model trained to forecast sentiments for users based on user information, based on the historical data for the user input to the predictive model, a forecasted sentiment for the user of the second device, and
mapping the forecasted sentiment to the response action for the asset.

12. The system of claim 11, wherein the response action comprises sending an instruction to the second device that causes an emotive avatar of a user of the second device to be sent to the first device.

13. The system of claim 8, wherein the causing the asset to be sent to the second device comprises sending the second device an interactive notification that causes the second device to display the asset based on an interaction with the interactive notification.

14. The system of claim 8, wherein the causing the asset to be sent to the second device comprises causing the asset to be sent to the second device from at least one of the first device or a content source.

15. A non-transitory computer-readable medium having instructions stored thereon that, when executed by at least one computing device, causes the at least one computing device to perform operations for asset-invoked reaction indication, the operations comprising:
receiving, from a first device, a request to send an asset to a second device;
identifying, based on a user profile associated with the second device and a type of the asset, a response action for the asset;
causing, based on the identifying the response action, the asset to be sent to the second device; and
triggering, based on an indication that the second device received the asset, the response action.

16. The non-transitory computer-readable medium of claim 15, wherein the identifying the response action for the asset comprises:
determining, based on an identifier of the second device received with the request to send the asset, the user profile and a plurality of response parameters indicated by the user profile; and
mapping a response parameter of the plurality of response parameters for the type of the asset to the response action for the asset.

17. The non-transitory computer-readable medium of claim 15, wherein the response action comprises sending an instruction to the second device that causes at least one of audio content indicative of a user of the second device or video content indicative of the user to be sent to the first device.

18. The non-transitory computer-readable medium of claim 15, wherein the identifying the response action for the asset comprises:
determining, based on an identifier of the second device received with the request to send the asset, the user profile and historical information for a user of the second device indicated by the user profile;
receiving from a predictive model trained to forecast sentiments for users based on user information, based on the historical data for the user input to the predictive model, a forecasted sentiment for the user of the second device, and
mapping the forecasted sentiment to the response action for the asset.

19. The non-transitory computer-readable medium of claim 18, wherein the response action comprises sending an instruction to the second device that causes an emotive avatar of a user of the second device to be sent to the first device.

20. The non-transitory computer-readable medium of claim 15, wherein the causing the asset to be sent to the second device comprises sending the second device an interactive notification that causes the second device to display the asset based on an interaction with the interactive notification.
